(19) United States
(12) Patent Application Publication
(10) Pub. No.: US 2025/0078832 A1
(43) Pub. Date: Mar. 6, 2025

(54) SPEECH RECOGNITION METHOD AND APPARATUS, ELECTRONIC DEVICE, AND STORAGE MEDIUM

(71) Applicant: BEIJING ZITIAO NETWORK TECHNOLOGY CO., LTD., Haidian District, Beijing (CN)

(72) Inventor: Yongsen JIANG, Beijing (CN)

(21) Appl. No.: 18/725,708

(22) PCT Filed: Mar. 31, 2023
(86) PCT No.: PCT/CN2023/085410

§ 371 Date: Jun. 28, 2024

(30) Foreign Application Priority Data
Apr. 21, 2022 (CN) 202210426886.0

(51) Int. Cl. G10L 15/22; G06N 3/0442; G10L 15/16

(52) U.S. Cl. CPC G10L 15/22; G06N 3/0442; G10L 15/16

(57) ABSTRACT

Disclosed in embodiments of the present disclosure are a speech recognition method and apparatus, an electronic device, and a storage medium. The method comprises: inputting a speech segment to be recognized into a long short-term memory (LSTM) model; and processing the speech segment by means of the LSTM model to obtain a speech recognition result, wherein the LSTM model comprises at least one processing layer, each processing layer comprises a plurality of processing units, and each processing unit determines the output amount at a target moment of a corresponding unit by means of two single loops on the basis of an input data set of the corresponding unit and a historical state data set before the target moment.

### CROSS-REFERENCE TO RELATED APPLICATIONS

The present application is based on and claims priority to Chinese Application No. 202210426886.0 filed on Apr. 21, 2022, the disclosure of which is incorporated by reference herein in its entirety.

### TECHNICAL FIELD

The present disclosure relates to the field of information technologies, and in particular a speech recognition method and apparatus, an electronic device, and a storage medium.

### BACKGROUND

In speech recognition, high recognition accuracy is usually obtained with the aid of language models. Common language models include the Long Short Term Memory (LSTM) model.

In the process of performing speech recognition based on the LSTM model, the most accurate one will be usually determined from a plurality of Chinese characters or syllables corresponding to an audio frame at a certain time through a series of operations.

### SUMMARY

Embodiments of the present disclosure provide a speech recognition method and apparatus, an electronic device, and a storage medium.

An embodiment of the present disclosure provides a speech recognition method, comprising:
inputting a to-be-recognized speech segment to a Long Short Term Memory (LSTM) model;
processing the to-be-recognized speech segment through the LSTM model so as to obtain a speech recognition result;
wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time;
an output of a former processing layer of two adjacent processing layers serves as an input of a latter processing layer, and an output of a former processing unit of two adjacent processing units serves as an input of a latter processing unit;
an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

An embodiment of the present disclosure further provides a speech recognition apparatus, comprising:
an input module for inputting a to-be-recognized speech segment to a Long Short Term Memory (LSTM) model;
a processing module for processing the to-be-recognized speech segment through the LSTM model so as to obtain a speech recognition result;
wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time;
an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

An embodiment of the present disclosure provides an electronic device, which comprises:
one or more processors;
a storage means for storing one or more programs;
wherein the one or more programs, when executed by the one or more processors, cause the one or more processors to implement the speech recognition method described above.

An embodiment of the present disclosure further provides a computer readable storage medium storing thereon a computer program which, when executed by a processor, implements the speech recognition method described above.

An embodiment of the present disclosure further provides a computer program product comprising a computer program or instructions which, when executed by a processor, cause the processor to implement the speech recognition method described above.

An embodiment of the present disclosure further provides a computer program, comprising computer readable instructions which, when executed by a processor, cause the processor to implement the speech recognition method described above.

### BRIEF DESCRIPTION OF THE DRAWINGS

The above and other features, advantages and aspects of embodiments of the present disclosure will become more apparent by referring to the following detailed implementations when taken in conjunction with the accompanying drawings. Throughout the drawings, the same or similar reference numerals indicate the same or similar elements. It should be understood that the drawings are schematic, and the components and elements are not necessarily drawn to scale.

FIG. 1 is a schematic structural diagram of an LSTM model including three cascaded processing layers in an embodiment of the present disclosure;

FIG. 2 is a schematic structural diagram of a processing layer including a plurality of processing units in an embodiment of the present disclosure;

FIG. 3 is a schematic structural diagram of a processing unit in an embodiment of the present disclosure;

FIG. 4 is a flow diagram of a speech recognition method in an embodiment of the present disclosure;

FIG. 5 is a schematic structural diagram of a speech recognition apparatus in an embodiment of the present disclosure;

FIG. 6 is a schematic structural diagram of an electronic device in an embodiment of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure can be implemented in various forms and should not be construed as limited to the embodiments set forth here, but rather, these embodiments are provided for a more thorough and complete understanding of the present disclosure. It should be understood that the drawings and embodiments of the present disclosure are only used for illustrative purposes, and are not used to limit the protection scope of the present disclosure.

It should be understood that the steps described in the method implementations of the present disclosure can be executed in a different order and/or in parallel. Furthermore, method implementations can include additional steps and/or omit performing the illustrated steps. The scope of the present disclosure is not limited in this respect.

As used herein, the term “including” and its variants are open-ended including, that is, “including but not limited to”. The term “based on” is “at least partially based on”. The term “one embodiment” means “at least one embodiment”; the term “another embodiment” means “at least one other embodiment”; the term “some embodiments” means “at least some embodiments”. Related definitions of other terms will be given in the following description.

It is to be noted that the concepts of “first” and “second” mentioned in the present disclosure are only used to distinguish different apparatuses, modules or units, and are not used to limit the order or interdependence of the functions executed by these apparatuses, modules or units.

It is to be noted that the modifications of “one” and “a plurality” mentioned in the present disclosure are schematic rather than limiting, and those skilled in the art should understand that unless the context clearly indicates otherwise, they should be understood as “one or a plurality of”.

Names of messages or information exchanged among a plurality of apparatuses in the embodiments of the present disclosure are only used for illustrative purposes, and are not used to limit the scope of these messages or information.

At present, in the process of performing speech recognition based on the LSTM model, there are problems of a large operation volume and a slow operation speed. The embodiments of the present disclosure provide a speech recognition method and apparatus, an electronic device, and a storage medium, so as to reduce the operation volume, and improve the operation speed and the speech recognition efficiency.

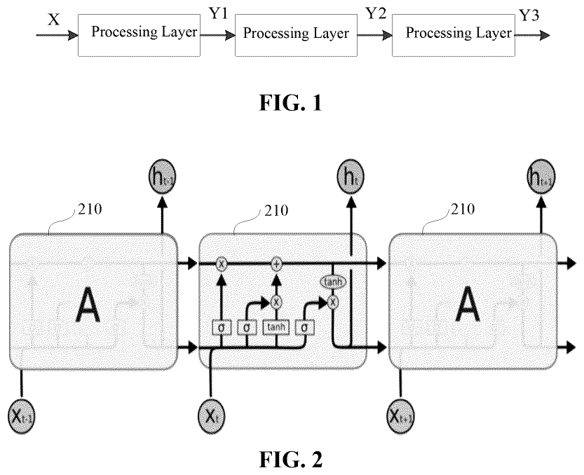

Generally, the LSTM model includes at least one cascaded processing layer. If the LSTM model includes a plurality of cascaded processing layers, then an output of a previous processing layer serves as an input of a next processing layer. Taking the LSTM model including three cascaded processing layers as an example, the schematic structural diagram of the LSTM model is shown in FIG. 1.

In the process of processing the to-be-recognized speech segments through the LSTM model, a plurality of recognition units (Chinese characters or syllables) with high probability of corresponding to an audio frame at a certain time will be usually selected as an initial input of the LSTM model, namely an input of a first processing layer of the LSTM model. For example, the Chinese characters with high probability of corresponding to the audio frame at time t can be “ [symbol] ”, “ [symbol] ” and “ [symbol] ” which serve as the input of the first processing layer of the LSTM model, and then a most accurate one is determined from the plurality of Chinese characters (“ [symbol] ”, “ [symbol] ” and “ [symbol] ”) as a speech recognition result corresponding to the audio frame at time t by performing a series of operations in each processing layer of the LSTM model.

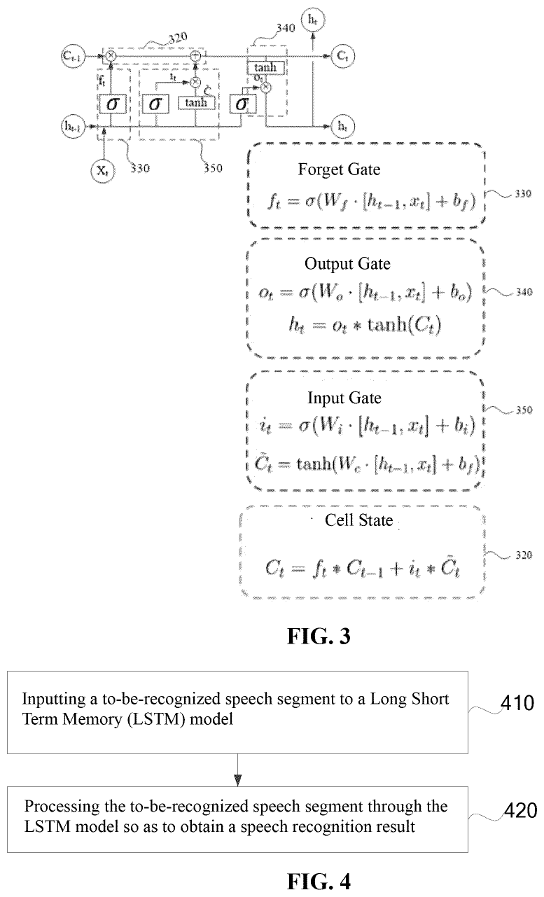

Specifically, in the operation process of each processing layer, a historical state corresponding to the audio frame at a certain time will be added. Referring to the schematic structural diagram of a processing layer including a plurality of processing units as shown in FIG. 2, one processing layer includes a plurality of processing units 210, and the schematic structural diagram of each processing unit 210 can refer to FIG. 3.

As learned from FIG. 2, an output of a former processing unit of two adjacent processing units serves as an input of a latter processing unit. As learned from FIG. 3, an input of the processing unit includes an input data set Xₜ, a correlation quantity Cₜ₋₁ and a historical state data set hₜ₋₁ corresponding to the input data set Xₜ prior to time t, and an output of the processing unit includes a historical state data set hₜ at time t and a correlation quantity Cₜ at time t. The input data set Xₜ can specifically represent vectors of a plurality of Chinese characters corresponding to the i-th audio frame at time t and a first matching degree that each Chinese character corresponds to the i-th audio frame (the first matching degree can also be understood as probability that each Chinese character is a speech recognition result of the i-th audio frame), the output quantity hₜ represents vectors of a plurality of Chinese characters corresponding to the i-th audio frame and a third matching degree that each Chinese character corresponds to the i-th audio frame; the third matching degree is different from the first matching degree; hₜ₋₁ is vectors of a plurality of Chinese characters corresponding to the (i−1)-th audio frame at time t−1 and a second matching degree of the Chinese characters corresponding to the (i−1)-th audio frame. By combining with the historical state data set, the purpose of determining the following text: from the preceding text is realized, and it is beneficial to improve the recognition accuracy. Correlation quantities Cₜ₋₁ and Cₜ represent cell states at different times, which are used for recording model parameters but do not represent specific physical meanings.

The processing unit determines the output quantity hₜ of the unit based on the input data set Xₜ, the correlation quantity Cₜ₋₁ and the historical state data set hₜ₋₁ corresponding to the input data set Xₜ prior to the time t of the unit.

As shown in FIG. 3, a processing unit (this specific processing unit is marked as a target processing unit) can include a Cell State update module 320, a Forget Gate 330, an Output Gate 340, and an Input Gate 350. The Forget Gate 330 is used for deciding which information is to be discarded from the cell state Cₜ₋₁; the Input Gate 350 is used for deciding which pieces of new information are to be saved in the cell state; the Cell State update module 320 is used for updating an old cell state Cₜ₋₁ to a new cell state Cₜ; the Output Gate 340 is used for determining an output quantity.

Correspondingly, an input of the target processing unit includes an output of a last processing unit adjacent to the target processing unit, wherein the output of the last processing unit includes a historical state data set Hₜ₋₁ which includes a plurality of historical state subsets hₜ₋₁, and a cell state Cₜ₋₁. The input of the target processing unit also includes an input data set Xₜ which includes a plurality of input subsets xₜ. An output (Cₜ and hₜ) of the target processing unit serves as an input of a next processing unit adjacent to the target processing unit.

As learned from FIG. 3, the operation process of each processing unit includes many matrix multiplication operations as follows: y=xₜ·A+hₜ₋₁·B, xₜ∈Xₜ, hₜ₋₁∈Hₜ₋₁, where y represents an intermediate quantity involved in the operation process, which is used for determining an output quantity hₜ. As shown in FIG. 3, y can be a parameter fₜ in the Forget Gate 330, where matrices A and B correspond to a model parameter matrix W_{f}; y can also be a parameter it in the Input Gate 350, where the matrices A and B correspond to a model parameter matrix Wᵢ. xₜ represents a vector of an optional Chinese character corresponding to the i-th audio frame at time t; Xₜ represents a set composed of a plurality of xₜ; hₜ₋₁ represents a vector of an optional Chinese character corresponding to the (i−1)-th audio frame at time t−1; Hₜ₋₁ represents a set composed of a plurality of hₜ₋₁; A and B respectively represent different matrices. Assuming that the number of xₜ is 10 and the number of hₜ₋₁ is 10, there are 100 possible results of y.

For the above-mentioned operation problem of y, it is usually to first set xₜ unchanged and change hₜ₋₁ until each hₜ₋₁ in Hₜ₋₁ is traversed, and then change xₜ, and repeat the above process. The above processing mode has the following problem: every time hₜ₋₁ is changed, it is necessary to execute a matrix multiplication operation xₜ·A, which causes the matrix multiplication xₜ·A to be repeatedly executed. Similarly, after xₜ is changed, it is also necessary to repeatedly execute a matrix multiplication operation hₜ₋₁. B. Assuming that the number of xₜ is 10 and the number of hₜ₋₁ is 10, for the above-mentioned operation problem of y, it is necessary to execute the operation xₜ19 A+hₜ₋₁·B totally 100 times according to the existing processing mode, which has the problems of a large operation volume and a slow operation speed.

For the above problems, the embodiment of the present disclosure provides a speech recognition method, which aims to reduce the operation volume inside the LSTM model, and improve the operation speed, SO as to improve the speech recognition efficiency.

FIG. 4 is a flow diagram of a speech recognition method in an embodiment of the present disclosure, which can be executed by a speech recognition apparatus. The apparatus can be implemented by means of software and/or hardware, and can be configured in an electronic device, such as a terminal, including but not limited to a smart phone, a palmtop computer, a tablet computer, a wearable device, a desktop, a notebook computer, an all-in-one machine, a smart home device and the like. Alternatively, it can be configured in a server.

As shown in FIG. 4, the method comprises the following steps:

Step 410: inputting a to-be-recognized speech segment to a Long Short Term Memory (LSTM) model.

Step 420: processing the to-be-recognized speech segment through the LSTM model so as to obtain a speech recognition result.

Illustratively, reference can be made to the schematic structural diagram of an LSTM model including a plurality of processing layers as shown in FIG. 1 and the schematic structural diagram of a processing layer including a plurality of processing units as shown in FIG. 2. The LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time; an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result. In the speech recognition scene, the vectors of a plurality of recognition units (Chinese characters or syllables) corresponding to each audio frame of the to-be-recognized speech segment is respectively input to the corresponding processing unit as an input data set of the corresponding processing unit. For example, vector Xₜ₋₁ of a plurality of optional Chinese characters corresponding to the (i−1)-th audio frame at time t−1 is input to a first processing unit, vector Xₜ of a plurality of optional Chinese characters corresponding to the i-th audio frame at time t is input to a second processing unit, and vector Xₜ₊₁ of a plurality of optional Chinese characters corresponding to the (i+1)-th audio frame at time t+1 is input to a third processing unit.

A plurality of optional Chinese characters corresponding to a different audio frame at a different time are usually Chinese characters with high probability of corresponding to the speech recognition result of the audio frame. For example, Chinese characters with high probability of corresponding to an audio frame at time t are possibly “ [symbol] ”, “ [symbol] ” and “ [symbol] ” which serve as an input data set Xₜ of a processing unit, and the input data set Xₜ includes a plurality of input subsets xₜ, each of which represents a vector of a Chinese character.

In summary, the input data set of the target processing unit includes vectors of a plurality of recognition units corresponding to the i-th audio frame of the to-be-recognized speech segment at time t and a first matching degree corresponding to each recognition unit; the historical state subset of the target processing unit includes vectors of a plurality of recognition units corresponding to the (i−1)-th audio frame of the to-be-recognized speech segment at time (t−1) and a second matching degree corresponding to each recognition unit; the output quantity of the target processing unit includes vectors of a plurality of recognition units corresponding to the i-th audio frame of the to-be-recognized speech segment at time t and a third matching degree corresponding to each recognition unit; wherein the third matching degree is different from the second matching degree, and the third matching degree is used for determining a speech recognition result of the i-th audio frame. That is, the matching degree between each Chinese character and the i-th audio frame can be changed through the processing of the target processing unit, and the speech recognition result of the i-th audio frame is finally obtained through the processing of a plurality of processing units.

Specifically, the output quantity of each of the processing units is determined based on a sum of the product of the input data set of the corresponding unit and the first matrix and the product of the historical data set of the corresponding unit and the second matrix. The input data set includes a plurality of input subsets, and the historical state data set includes a plurality of historical state subsets.

As learned from FIG. 3, the operation process of each processing unit includes many matrix multiplication operations as follows: y=xₜ·A+hₜ₋₁·B, xₜ∈Xₜ, hₜ₋₁∈Hₜ₋₁, where, A can be understood as the first matrix mentioned in the embodiment of the present disclosure and B can be understood as the second matrix mentioned in the embodiment of the present disclosure; y represents an intermediate quantity involved in the operation process, which is used for determining an output quantity hₜ; xₜ represents a vector of an optional Chinese character corresponding to the i-th audio frame at time t; Xₜ represents a set composed of a plurality of xₜ; hₜ₋₁ represents a vector of an optional Chinese character corresponding to the (i−1)-th audio frame at time t−1; Hₜ₋₁ represents a set composed of a plurality of hₜ₋₁; A and B respectively represent different matrices. Assuming that the number of xₜ is 10 and the number of hₜ₋₁ is 10, there are 100 possible results of y.

For the above-mentioned operation problem of y, it is usually to first set xₜ unchanged and change hₜ₋₁ until each hₜ₋₁ in Hₜ₋₁ is traversed, then change xₜ, and repeat the above process. The above processing mode has the following problem: every time hₜ₋₁ is changed, it is necessary to execute a matrix multiplication operation xₜ·A, which causes the matrix multiplication xₜ·A to be repeatedly executed. Similarly, after xₜ is changed, it is also necessary to repeatedly execute a matrix multiplication operation hₜ₋₁. B. Assuming that the number of xₜ is 10 and the number of hₜ₋₁ is 10, for the above-mentioned operation problem of y, it is necessary to perform the operation xₜ·A+hₜ₋₁·B totally 100 times according to the existing processing mode, which has the problems of a large operation volume and a slow operation speed.

However, in the embodiment of the present disclosure, the above matrix multiplication operation (y=xₜ·A+hₜ₋₁·B, xₜ∈Xₜ, hₜ₋₁∈Hₜ₋₁) is performed through two single loops, rather than through one double loop as descried above.

Specifically, for each input subset xₜ in the input data set Xₜ, the product of each input subset xₜ and the first matrix A is respectively determined so as to obtain a third matrix. For example, there are totally 10 input subsets, which are denoted as x₁, x₂, x₃, x₄, x₅, x₆, x₇, x₈, x₉ and x₁₀ respectively. Then, the product of x₁ and matrix A is calculated to obtain y11; the product of x₂ and matrix A is calculated to obtain y12; the product of x₃ and matrix A is calculated to obtain y13, the product of x₄ and matrix A is calculated to obtain y14; the product of x₅ and matrix A is calculated to obtain y15; the product of x₆ and matrix A is calculated to obtain y16; the product of x₇ and matrix A is calculated to obtain y17; the product of x₈ and matrix A is calculated to obtain y18; the product of x₉ and matrix A is calculated to obtain y19; the product of x₁₀ and matrix A is calculated to obtain y110. Then the third matrix is [y11, y12, y13, y14, y15, y16, y17, y18, y19, y110]. To sum up, it requires to perform the multiplication operation with the first matrix A totally 10 times so as to obtain the third matrix. The above-mentioned process belongs to one single loop.

Similarly, for each historical state subset hₜ₋₁ in the historical state data set Hₜ₋₁ prior to the target time, the product of each historical state subset hₜ₋₁ and the second matrix B is determined respectively so as to obtain a fourth matrix. For example, there are totally 10 historical state subsets, which are respectively denoted as h₁, h₂, h₃, h₄, h₅, h₆, h₇, h₈, h₉ and h₁₀. Then, the product of hi and matrix B is calculated to obtain y21; the product of h₂ and matrix B is calculated to obtain y22; the product of h₃ and matrix B is calculated to obtain y23; the product of h₄ and matrix B is calculated to obtain y24; the product of h₅ and matrix B is calculated to obtain y25; the product of ho and matrix B is calculated to obtain y26; the product of h₇ and matrix B is calculated to obtain y27; the product of h₈ and matrix B is calculated to obtain y28; the product of h₉ and matrix A is calculated to obtain y29; and the product of h₁₀ and matrix B is calculated to obtain y210, respectively. Then a fourth matrix is [y21, y22, y23, y24, y25, y26, y27, y28, y29, y210]. To sum up, it requires to perform the multiplication operation with the second matrix B totally 10 times so as to obtain the fourth matrix, and the above process also belongs to one single loop. Therefore, in the embodiment of the present disclosure, the above-mentioned matrix multiplication operation (y=xₜ·A+hₜ₋₁·B, xₜ∈Xₜ, hₜ₋₁∈Hₜ₋₁) is performed through two single loops, which requires to perform the matrix multiplication operation totally 20 times. Compared with performing the matrix multiplication operation 100 times, the operation volume is reduced, and the operation efficiency is improved, so that the speech recognition efficiency is improved.

Further, an intermediate quantity is determined based on the third matrix and the fourth matrix, and the intermediate quantity is used for determining an output quantity for the target time of the corresponding unit. Specifically, the output quantity for the target time can be determined according to the operation formula of each logic gate in FIG. 3.

In summary, the determining, for each input subset in the input data set of the corresponding unit, a product of each input subset and the first matrix respectively so as to obtain a third matrix comprises:
determining, for a current input subset, a product of the current input subset and the first matrix as a first result corresponding to the current input subset, the current input subset being one of the plurality of input subsets; ranking the first result corresponding to each input subset according to a ranking relation of each input subset in the input data set so as to obtain a third matrix.

The determining, for each historical state subset in the historical state data set prior to the target time of the corresponding unit, a product of each historical state subset and the second matrix respectively so as to obtain a fourth matrix comprises:
determining, for a current historical state subset, a product of the current historical state subset and the second matrix as a second result corresponding to the current historical state subset, the current historical state subset being one of the plurality of historical state subsets; ranking the second result corresponding to each historical state subset according to a ranking relation of each historical state subset in the historical state data set so as to obtain a fourth matrix.

The determining an intermediate quantity based on the third matrix and the fourth matrix includes: performing a matrix addition operation on the third matrix and the fourth matrix so as to obtain the intermediate quantity.

According to the speech recognition method provided by the embodiment of the present disclosure, when the matrix multiplication operation is performed inside the LSTM model, it is performed through two single loops, so that the operation volume can be reduced, and the operation speed and the speech recognition efficiency can be improved.

FIG. 5 is a schematic structural diagram of a speech recognition apparatus in an embodiment of the present disclosure. The speech recognition apparatus provided by the embodiment of the present disclosure can be configured in a client or a server, and the apparatus specifically includes:
an input module 510 for inputting a to-be-recognized speech segment to a Long Short Term Memory (LSTM) model;
a processing module 520 for determining, based on the intermediate quantity, an output quantity of the target unit which is used for determining a speech recognition result, wherein, the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time; an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

Optionally, the output quantity of each of the processing units is determined based on a sum of a product of the input data set of the corresponding unit and a first matrix and a product of the historical state data set of the corresponding unit and a second matrix. The input data set comprises a plurality of input subsets, and the historical state data set comprises a plurality of historical state subsets.

Optionally, the processing module 520 includes a first determination unit for determining, for each input subset in the input data set of the corresponding unit, a product of each input subset and the first matrix respectively so as to obtain a third matrix; a second determination unit for determining, for each historical state subset in the historical state data set prior to the target time of the corresponding unit, a product of each historical state subset and the second matrix respectively so as to obtain a fourth matrix; a third determination unit for determining an intermediate quantity based on the third matrix and the fourth matrix, which is used for determining an output quantity for the target time of the corresponding unit.

Optionally, the first determination unit is specifically used for determining, for a current input subset, a product of the current input subset and the first matrix as a first result corresponding to the current input subset, the current input subset being one of the plurality of input subsets; ranking the first result corresponding to each input subset according to a ranking relation of each input subset in the input data set so as to obtain a third matrix.

The second determination unit is specifically used for determining, for a current historical state subset, a product of the current historical state subset and the second matrix as a second result corresponding to the current historical state subset, the current historical state subset being one of the plurality of historical state subsets; ranking the second result corresponding to each historical state subset according to a ranking relation of each historical state subset in the historical state data set so as to obtain a fourth matrix.

Optionally, the third determination unit is specifically used for performing a matrix addition operation on the third matrix and the fourth matrix so as to obtain the intermediate quantity.

Optionally, the input data set of the target processing unit comprises vectors of a plurality of recognition units corresponding to the i-th audio frame of the to-be-recognized speech segment at time t and a first matching degree corresponding to each recognition unit; the historical state subset of the target processing unit comprises vectors of a plurality of recognition units corresponding to the (i−1)-th audio frame of the to-be-recognized speech segment at time (t−1) and a second matching degree corresponding to each recognition unit; the output quantity of the target processing unit comprises vectors of a plurality of recognition units corresponding to the i-th audio frame of the to-be-recognized speech segment at time t and a third matching degree corresponding to each recognition unit; wherein the third matching degree is different from the second matching degree, and the third matching degree is used for determining a speech recognition result of the i-th audio frame. The speech recognition apparatus provided by the embodiment of the present disclosure can execute the steps executed by the client or the server in the speech recognition method provided by the embodiment of the present disclosure, and has the execution steps and beneficial effects, which will not be described here.

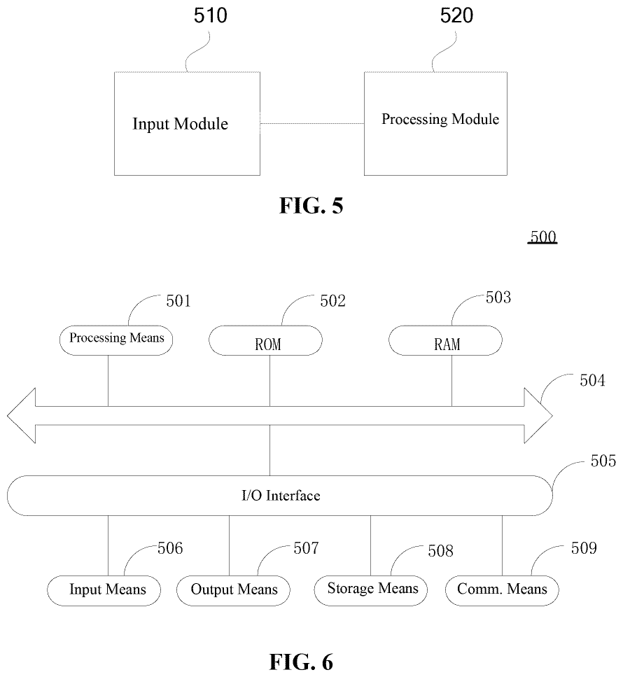

FIG. 6 is a schematic structural diagram of an electronic device in an embodiment of the present disclosure. Referring specifically to FIG. 6, there is shown a schematic structural diagram of an electronic device 500 suitable for implementing an embodiment of the present disclosure. The electronic device 500 in the embodiment of the present disclosure can include, but is not limited to, mobile terminals such as mobile phones, notebook computers, digital broadcast receivers, Personal Digital Assistants (PDAs), Tablet Computers (PADs), Portable Multimedia Players (PMPs), vehicle-mounted terminals (such as vehicle-mounted navigation terminals), wearable electronic devices and the like, as well as fixed terminals such as digital TV, desktop computers, smart home devices and the like. The electronic device shown in FIG. 6 is just an example, and should not bring any limitation to the functions and application scope of the embodiment of the present disclosure.

As shown in FIG. 6, the electronic device 500 can include a processing means (e.g., a central processor, a graphics processor, etc.) 501, which can execute various appropriate actions and processes according to a program stored in a Read-Only Memory (ROM) 502 or a program loaded from a storage means 508 into a Random Access Memory (RAM) 503 to implement the method according to the embodiment of the present disclosure. In the RAM 503, various programs and data required for the operation of the electronic device 500 are also stored. The processing means 501, the ROM 502 and the RAM 503 are connected to each other through a bus 504. An input/output (I/O) interface 505 is also connected to the bus 504.

Generally, the following means can be connected to the I/O interface 505: an input means 506 including, for example, a touch screen, a touch pad, a keyboard, a mouse, a camera, a microphone, an accelerometer, a gyroscope, and the like; an output means 507 including, for example, a liquid crystal display (LCD), a speaker, a vibrator, and the like; a storage device 508 including, for example, a magnetic tape, a hard disk, and the like; and a communication means 509. The communication means 509 can allow the electronic device 500 to communicate wirelessly or via wire with other devices to exchange data. Although FIG. 6 shows the electronic device 500 with various means, it should be understood that not all the illustrated means require to be implemented or provided. More or fewer means can alternatively be implemented or provided.

In particular, according to an embodiment of the present disclosure, the process described above with reference to the flow diagram can be implemented as a computer software program. For example, an embodiment of the present disclosure includes a computer program product including a computer program carried on a non-transient computer readable medium. The computer program contains program codes for executing the method shown in the flow diagram, thereby realizing the speech recognition method as described above. In such an embodiment, the computer program can be downloaded and installed from the network through the communication means 509, or installed from the storage means 508 or from the ROM 502. When the computer program is executed by the processing means 501, the above functions defined in the method of the embodiment of the present disclosure are executed.

It is to be noted that the computer readable medium mentioned above in the present disclosure can be a computer readable signal medium or a computer readable storage medium or any combination of the two. The computer readable storage medium can be, for example, but not limited to, an electrical, magnetic, optical, electromagnetic, infrared, or semiconductor system, apparatus, or device, or any combination of the above. More specific examples of the computer readable storage medium can include, but are not limited to, an electrical connection with one or more wires, a portable computer disk, a hard disk, a Random Access Memory (RAM), a Read-Only Memory (ROM), an Erasable Programmable Read-Only Memory (EPROM or flash memory), an optical fiber, a portable Compact Disk Read-Only Memory (CD-ROM), an optical storage device, a magnetic storage device, or any suitable combination of the above. In the present disclosure, the computer readable storage medium can be any tangible medium containing or storing a program, which can be used by or in combination with an instruction execution system, apparatus or device. In the present disclosure, the computer readable signal medium can include a data signal propagated in baseband or as part of a carrier wave, in which computer readable program codes are carried. This propagated data signal can take many forms, including but not limited to an electromagnetic signal, an optical signal or any appropriate combination of the above. The computer readable signal medium can also be any computer readable medium other than the computer readable storage medium, which can send, propagate or transmit a program for use by or in connection with an instruction execution system, apparatus or device. The program codes contained in the computer readable medium can be transmitted by any appropriate medium, including but not limited to: wires, optical cables, RF (radio frequency) and the like, or any appropriate combination of the above.

In some embodiments, clients and servers can communicate by using any currently known or future developed network protocol such as the HyperText Transfer Protocol (HTTP), and can be interconnected with digital data communication in any form or medium (for example, communication network). Examples of communication networks include a Local Area Network (“LAN”), a Wide Area Network (“WAN”), the Interconnection network (for example, the Internet) and end-to-end networks (for example, ad hoc end-to-end networks), as well as any currently known or future developed networks.

The above-mentioned computer readable medium can be contained in the above-mentioned electronic device, or can exist alone without being assembled into the electronic device.

The above-mentioned computer readable medium carries one or more programs which, when executed by the electronic device, cause the electronic device to: input a to-be-recognized speech segment to a Long Short Term Memory (LSTM) model; process the to-be-recognized speech segment through the LSTM model so as to obtain a speech recognition result; wherein, the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time; an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result. Optionally, when the above one or more programs are executed by the electronic device, the electronic device can also execute other steps described in the above embodiment.

Computer program codes for executing the operations of the present disclosure can be written in one or more programming languages or a combination thereof, including but not limited to object-oriented programming languages, such as Java, Smalltalk, C++, as well as conventional procedural programming languages, such as “C” language or similar programming languages. The program codes can be completely executed on the user's computer, partially executed on the user's computer, executed as an independent software package, partially executed on the user's computer and partially executed on a remote computer, or completely executed on the remote computer or server. In the case involving a remote computer, the remote computer can be connected to a user's computer through any kind of network, including a Local Area Network (LAN) or a Wide Area Network (WAN), or can be connected to an external computer (for example, through the Internet using an Internet service provider).

The flow diagrams and block diagrams in the drawings illustrate the architecture, functions and operations of possible implementations of the system, method and computer program product according to various embodiments of the present disclosure. In this regard, each block in the flow diagrams or block diagrams can represent a module, a program segment, or a part of code that contains one or more executable instructions for implementing specified logical functions. It should also be noted that in some alternative implementations, the functions noted in the blocks can occur in a different order than those noted in the drawings. For example, two blocks shown in succession can actually be executed substantially in parallel, and they can sometimes be executed in the reverse order, depending on the functions involved. It is also to be noted that each block in the block diagrams and/or flow diagrams, and a combination of blocks in the block diagrams and/or flow diagrams, can be implemented by a dedicated hardware-based system that executes specified functions or operations, or by a combination of dedicated hardware and computer instructions.

The involved units described in the embodiments of the present disclosure can be implemented by software or hardware. The name of the unit does not constitute the limitation of the unit itself in some cases.

The functions described above herein can be at least partially executed by one or more hardware logic components. For example, without limitation, exemplary types of hardware logic components that can be used include: Field Programmable Gate Array (FPGA), Application Specific Integrated Circuit (ASIC), Application Specific Standard Product (ASSP), System on Chip (SOC), Complex Programmable Logic Device (CPLD) and so on.

In the context of the present disclosure, a machine readable medium can be a tangible medium that can contain or store a program for use by or in connection with an instruction execution system, apparatus or device. The machine readable medium can be a machine readable signal medium or a machine readable storage medium. The machine readable medium can include, but is not limited to, an electronic, magnetic, optical, electromagnetic, infrared, or semiconductor system, apparatus, device, or any appropriate combination of the above. More specific examples of the machine readable storage medium can include an electrical connection based on one or more wires, a portable computer disk, a hard disk, a Random Access Memory (RAM), a Read-Only Memory (ROM), an Erasable Programmable Read-Only Memory (EPROM or flash memory), an optical fiber, a convenient Compact Disk Read-Only Memory (CD-ROM), an optical storage device, a magnetic storage device, or any appropriate combination of the above.

According to one or more embodiments of the present disclosure, the present disclosure provides a speech recognition method, including: inputting a to-be-recognized speech segment to a Long Short Term Memory (LSTM) model; processing the to-be-recognized speech segment through the LSTM model so as to obtain a speech recognition result; wherein, the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time; an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result. According to one or more embodiments of the present disclosure, in the speech recognition method provided by the present disclosure, optionally, the output quantity of each of the processing units is determined based on a sum of a product of the input data set of the corresponding unit and a first matrix and a product of the historical state data set of the corresponding unit and a second matrix; the input data set comprises a plurality of input subsets, and the historical state data set comprises a plurality of historical state subsets.

According to one or more embodiments of the present disclosure, in the speech recognition method provided by the present disclosure, optionally, each of the processing units determining an output quantity for the target time of the corresponding unit through two single loops based on an input data set of the corresponding unit and a historical state data set prior to a target time comprises: determining, for each input subset in the input data set of the corresponding unit, a product of each input subset and the first matrix respectively so as to obtain a third matrix; determining, for each historical state subset in the historical state data set prior to the target time of the corresponding unit, a product of each historical state subset and the second matrix respectively so as to obtain a fourth matrix; determining an intermediate quantity based on the third matrix and the fourth matrix, which is used for determining an output quantity for the target time of the corresponding unit. According to one or more embodiments of the present disclosure, in the speech recognition method provided by the present disclosure, optionally, the determining, for each input subset in the input data set of the corresponding unit, a product of each input subset and the first matrix respectively so as to obtain a third matrix comprises: determining, for a current input subset, a product of the current input subset and the first matrix as a first result corresponding to the current input subset, the current input subset being one of the plurality of input subsets; ranking the first result corresponding to each input subset according to a ranking relation of each input subset in the input data set so as to obtain a third matrix.

According to one or more embodiments of the present disclosure, in the speech recognition method provided by the present disclosure, optionally, the determining, for each historical state subset in the historical state data set prior to the target time of the corresponding unit, a product of each historical state subset and the second matrix respectively so as to obtain a fourth matrix comprises: determining, for a current historical state subset, a product of the current historical state subset and the second matrix as a second result corresponding to the current historical state subset, the current historical state subset being one of the plurality of historical state subsets; ranking the second result corresponding to each historical state subset according to a ranking relation of each historical state subset in the historical state data set so as to obtain a fourth matrix.

According to one or more embodiments of the present disclosure, in the speech recognition method provided by the present disclosure, optionally, the determining an intermediate quantity based on the third matrix and the fourth matrix includes: performing a matrix addition operation on the third matrix and the fourth matrix so as to obtain the intermediate quantity.

According to one or more embodiments of the present disclosure, in the speech recognition method provided by the present disclosure, optionally, the input data set of the target processing unit comprises vectors of a plurality of recognition units corresponding to the i-th audio frame of the to-be-recognized speech segment at time t and a first matching degree corresponding to each recognition unit; the historical state subset of the target processing unit comprises vectors of a plurality of recognition units corresponding to the (i−1)-th audio frame of the to-be-recognized speech segment at time (t−1) and a second matching degree corresponding to each recognition unit; the output quantity of the target processing unit comprises vectors of a plurality of recognition units corresponding to the i-th audio frame of the to-be-recognized speech segment at time t and a third matching degree corresponding to each recognition unit; wherein the third matching degree is different from the second matching degree, and the third matching degree is used for determining a speech recognition result of the i-th audio frame.

According to one or more embodiments of the present disclosure, the present disclosure provides a speech recognition apparatus, comprising: an input module for inputting a to-be-recognized speech segment to a Long Short Term Memory (LSTM) model; a processing module for processing the to-be-recognized speech segment through the LSTM model so as to obtain a speech recognition result; wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity at each time prior to the target time comprises the historical state data set prior to the target time; an output of a former processing layer of two adjacent processing layers serves as an input of a latter processing layer, and an output of a former processing unit of two adjacent processing units serves as an input of a latter processing unit; an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

According to one or more embodiments of the present disclosure, the present disclosure provides an electronic device, comprising:
one or more processors;
a memory for storing one or more programs;
wherein the one or more programs, when executed by the one or more processors, cause the one or more processors to implement any of the speech recognition method as provided by the present disclosure.

According to one or more embodiments of the present disclosure, the present disclosure provides a computer readable storage medium storing thereon a computer program which, when executed by a processor, implements any of the speech recognition methods as provided by the present disclosure.

According to one or more embodiments of the present disclosure, the present disclosure provides a computer program, comprising computer readable instructions which, when executed by a processor, cause the processor to implement any of the speech recognition methods as provided by the present disclosure.

Compared with the related art, the technical solution provided by the embodiments of the present disclosure has at least the following advantages: the speech recognition method provided by the embodiments of the present disclosure determines an output quantity for the target time of the corresponding unit through two single loops, which can reduce the operation volume and improve the operation speed and the speech recognition efficiency.

The above description is only the explanation of the preferred embodiments of the present disclosure and the applied technical principles. It should be understood by those skilled in the art that the disclosure scope involved in the present disclosure is not limited to the technical solution formed by the specific combination of the above technical features, but also covers other technical solution formed by any combination of the above technical features or their equivalent features without departing from the above disclosure concept, for example, a technical solution formed by a mutual replacement of the above features technical features with similar functions as disclosed in the present disclosure (but not limited to).

Furthermore, although the operations are depicted in a particular order, this should not be understood as requiring that these operations be executed in the particular order shown or in a sequential order. Under certain circumstances, multitasking and parallel processing may be beneficial. Likewise, although several specific implementation details are contained in the above discussion, these should not be construed as limiting the scope of the present disclosure. Some features described in the context of a separate embodiment can also be implemented in combination in a single embodiment. On the contrary, various features described in the context of a single embodiment can also be implemented in multiple embodiments individually or in any appropriate sub-combination.

Although the present subject matter has been described in a language specific to structural features and/or methodological logical actions, it should be understood that the subject matter defined in the appended Claims is not necessarily limited to the specific features or actions described above. On the contrary, the specific features and actions described above are only exemplary forms of implementing the Claims.

1. A speech recognition method, comprising:
inputting a to-be-recognized speech segment to a Long Short Term Memory (LSTM) model;
processing the to-be-recognized speech segment through the LSTM model so as to obtain a speech recognition result;
wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time;
wherein an output of a former processing layer of two adjacent processing layers serves as an input of a latter processing layer, and an output of a former processing unit of two adjacent processing units serves as an input of a latter processing unit;
wherein an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

2. The speech recognition method according to claim 1, wherein the output quantity of each of the processing units is determined based on a sum of a product of the input data set of the corresponding unit and a first matrix and a product of the historical state data set of the corresponding unit and a second matrix;
the input data set comprises a plurality of input subsets, and the historical state data set comprises a plurality of historical state subsets.

3. The speech recognition method according to claim 2, wherein, each of the processing units determining an output quantity for the target time of the corresponding unit through two single loops based on an input data set of the corresponding unit and a historical state data set prior to a target time, comprises:
determining, for each input subset in the input data set of the corresponding unit, a product of each input subset and the first matrix respectively so as to obtain a third matrix;
determining, for each historical state subset in the historical state data set prior to the target time of the corresponding unit, a product of each historical state subset and the second matrix respectively so as to obtain a fourth matrix;
determining an intermediate quantity based on the third matrix and the fourth matrix, which is used for determining an output quantity for the target time of the corresponding unit.

4. The speech recognition method according to claim 3, wherein the determining, for each input subset in the input data set of the corresponding unit, a product of each input subset and the first matrix respectively so as to obtain a third matrix, comprises:
determining, for a current input subset, a product of the current input subset and the first matrix as a first result corresponding to the current input subset, the current input subset being one of the plurality of input subsets;
ranking the first result corresponding to each input subset according to a ranking relation of each input subset in the input data set so as to obtain a third matrix.

5. The speech recognition method according to claim 3, wherein, the determining, for each historical state subset in the historical state data set prior to the target time of the corresponding unit, a product of each historical state subset and the second matrix respectively so as to obtain a fourth matrix, comprises:
determining, for a current historical state subset, a product of the current historical state subset and the second matrix as a second result corresponding to the current historical state subset, the current historical state subset being one of the plurality of historical state subsets;
ranking the second result corresponding to each historical state subset according to a ranking relation of each historical state subset in the historical state data set so as to obtain a fourth matrix.

6. The speech recognition method according to claim 3, wherein, the determining an intermediate quantity based on the third matrix and the fourth matrix, comprises:
performing a matrix addition operation on the third matrix and the fourth matrix so as to obtain the intermediate quantity.

7. The speech recognition method according to claim 2, wherein the input data set of the target processing unit comprises vectors of a plurality of recognition units corresponding to the i-th audio frame of the to-be-recognized speech segment at time t and a first matching degree corresponding to each recognition unit;
the historical state subset of the target processing unit comprises vectors of a plurality of recognition units corresponding to the (i−1)-th audio frame of the to-be-recognized speech segment at time (t−1) and a second matching degree corresponding to each recognition unit;
the output quantity of the target processing unit comprises vectors of a plurality of recognition units corresponding to the i-th audio frame of the to-be-recognized speech segment at time t and a third matching degree corresponding to each recognition unit; wherein the third matching degree is different from the second matching degree, and the third matching degree is used for determining a speech recognition result of the i-th audio frame.

8. (canceled)

9. An electronic device, comprising:
one or more processors;
a storage means for storing one or more programs;
wherein the one or more programs, when executed by the one or more processors, cause the one or more processors to implement a speech recognition method comprising:
inputting a to-be-recognized speech segment to a Long Short Term Memory (LSTM) model;
processing the to-be-recognized speech segment through the LSTM model so as to obtain a speech recognition result;
wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time;
wherein an output of a former processing layer of two adjacent processing layers serves as an input of a latter processing layer, and an output of a former processing unit of two adjacent processing units serves as an input of a latter processing unit;
wherein an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

10. A non-transitory computer readable storage medium storing thereon a computer program which, when executed by a processor, implements a speech recognition method, comprising:
inputting a to-be-recognized speech segment to a Long Short Term Memory (LSTM) model;
processing the to-be-recognized speech segment through the LSTM model so as to obtain a speech recognition result;
wherein the LSTM model comprises at least one processing layer, each of the processing layers comprises a plurality of processing units respectively, each of the processing units determines an output quantity for the target time of the corresponding unit through two single loops based on an input data set of the corresponding unit and a historical state data set prior to a target time, the target time is a time corresponding to the input data set of the corresponding unit, and the output quantity for each time prior to the target time comprises the historical state data set prior to the target time;
wherein an output of a former processing layer of two adjacent processing layers serves as an input of a latter processing layer, and an output of a former processing unit of two adjacent processing units serves as an input of a latter processing unit;
wherein an input data set of a first processing layer of the LSTM model comprises vectors of a plurality of recognition units respectively corresponding to each audio frame in the to-be-recognized speech segment, and an output of a last processing layer of the LSTM model is used for determining the speech recognition result.

11-12. (canceled)

13. The electronic device according to claim 9, wherein the output quantity of each of the processing units is determined based on a sum of a product of the input data set of the corresponding unit and a first matrix and a product of the historical state data set of the corresponding unit and a second matrix;
the input data set comprises a plurality of input subsets, and the historical state data set comprises a plurality of historical state subsets.

14. The electronic device according to claim 13, wherein, each of the processing units determining an output quantity for the target time of the corresponding unit through two single loops based on an input data set of the corresponding unit and a historical state data set prior to a target time, comprises:
determining, for each input subset in the input data set of the corresponding unit, a product of each input subset and the first matrix respectively so as to obtain a third matrix;
determining, for each historical state subset in the historical state data set prior to the target time of the corresponding unit, a product of each historical state subset and the second matrix respectively so as to obtain a fourth matrix;
determining an intermediate quantity based on the third matrix and the fourth matrix, which is used for determining an output quantity for the target time of the corresponding unit.

15. The electronic device according to claim 14, wherein the determining, for each input subset in the input data set of the corresponding unit, a product of each input subset and the first matrix respectively so as to obtain a third matrix, comprises:
determining, for a current input subset, a product of the current input subset and the first matrix as a first result corresponding to the current input subset, the current input subset being one of the plurality of input subsets;
ranking the first result corresponding to each input subset according to a ranking relation of each input subset in the input data set so as to obtain a third matrix.

16. The electronic device according to claim 14, wherein, the determining, for each historical state subset in the historical state data set prior to the target time of the corresponding unit, a product of each historical state subset and the second matrix respectively so as to obtain a fourth matrix, comprises:
determining, for a current historical state subset, a product of the current historical state subset and the second matrix as a second result corresponding to the current historical state subset, the current historical state subset being one of the plurality of historical state subsets;
ranking the second result corresponding to each historical state subset according to a ranking relation of each historical state subset in the historical state data set so as to obtain a fourth matrix.

17. The electronic device according to claim 14, wherein, the determining an intermediate quantity based on the third matrix and the fourth matrix, comprises:
performing a matrix addition operation on the third matrix and the fourth matrix so as to obtain the intermediate quantity.

18. The electronic device according to claim 13, wherein the input data set of the target processing unit comprises vectors of a plurality of recognition units corresponding to the i-th audio frame of the to-be-recognized speech segment at time t and a first matching degree corresponding to each recognition unit;
the historical state subset of the target processing unit comprises vectors of a plurality of recognition units corresponding to the (i−1)-th audio frame of the to-be-recognized speech segment at time (t−1) and a second matching degree corresponding to each recognition unit;
the output quantity of the target processing unit comprises vectors of a plurality of recognition units corresponding to the i-th audio frame of the to-be-recognized speech segment at time t and a third matching degree corresponding to each recognition unit; wherein the third matching degree is different from the second matching degree, and the third matching degree is used for determining a speech recognition result of the i-th audio frame.

19. The non-transitory computer readable storage medium according to claim 10, wherein the output quantity of each of the processing units is determined based on a sum of a product of the input data set of the corresponding unit and a first matrix and a product of the historical state data set of the corresponding unit and a second matrix;
the input data set comprises a plurality of input subsets, and the historical state data set comprises a plurality of historical state subsets.

20. The non-transitory computer readable storage medium according to claim 19, wherein, each of the processing units determining an output quantity for the target time of the corresponding unit through two single loops based on an input data set of the corresponding unit and a historical state data set prior to a target time, comprises:
determining, for each input subset in the input data set of the corresponding unit, a product of each input subset and the first matrix respectively so as to obtain a third matrix;
determining, for each historical state subset in the historical state data set prior to the target time of the corresponding unit, a product of each historical state subset and the second matrix respectively so as to obtain a fourth matrix;
determining an intermediate quantity based on the third matrix and the fourth matrix, which is used for determining an output quantity for the target time of the corresponding unit.

21. The non-transitory computer readable storage medium according to claim 20, wherein the determining, for each input subset in the input data set of the corresponding unit, a product of each input subset and the first matrix respectively so as to obtain a third matrix, comprises:
determining, for a current input subset, a product of the current input subset and the first matrix as a first result corresponding to the current input subset, the current input subset being one of the plurality of input subsets;
ranking the first result corresponding to each input subset according to a ranking relation of each input subset in the input data set so as to obtain a third matrix.

22. The non-transitory computer readable storage medium according to claim 20, wherein, the determining, for each historical state subset in the historical state data set prior to the target time of the corresponding unit, a product of each historical state subset and the second matrix respectively so as to obtain a fourth matrix, comprises:
determining, for a current historical state subset, a product of the current historical state subset and the second matrix as a second result corresponding to the current historical state subset, the current historical state subset being one of the plurality of historical state subsets;
ranking the second result corresponding to each historical state subset according to a ranking relation of each historical state subset in the historical state data set so as to obtain a fourth matrix.

23. The non-transitory computer readable storage medium according to claim 20, wherein, the determining an intermediate quantity based on the third matrix and the fourth matrix, comprises:
performing a matrix addition operation on the third matrix and the fourth matrix so as to obtain the intermediate quantity.
